(19) United States
(12) Patent Application Publication
(10) Pub. No.: US 2018/0152360 A1
(43) Pub. Date: May 31, 2018

(54) BLOOM FILTERS TO LIMIT USE OF TRANSPORT RESOURCES IN IOT SCENARIOS

(71) Applicant: Microsoft Technology Licensing, LLC, Redmond, WA (US)

(72) Inventor: Bengt-Erik Norum, Duvall, WA (US)

(73) Assignee: Microsoft Technology Licensing, LLC, Redmond, WA (US)

(21) Appl. No.: 15/365,854

(22) Filed: Nov. 30, 2016

(51) Int. Cl. H04L 12/26; H04W 72/12; H04W 72/04

(52) U.S. Cl. CPC H04L 43/028; H04W 72/0453; H04W 72/1268; H04W 72/1289

(57) ABSTRACT

Use of Bloom filters to limit use of transport resources in Internet of Things (IoT) scenarios is disclosed. Efficient and less expensive data collection from a remote apparatus is provided through configuration of the parameters of a Bloom filter located at the remote apparatus. A Bloom filter may be used to reduce the amount of data collected at the remote apparatus to an amount of data better suited for transmission on available wireless channels. The Bloom filter parameters may be configured based on air interface considerations such as bandwidth and cost. The configuration of the Bloom filter may be performed dynamically based on parameters of the air interface on which the apparatus or network sends the collected data to a service for further processing. As the parameters on the air interface change, the parameters of the Bloom filter may be adapted to minimize use of expensive transport.

### BACKGROUND

Devices that collect and transmit data over wireless channels to the Internet of Things (IoT) have proliferated. These devices are now used for a large number of applications. An important aspect of this proliferation is an increasing demand for wireless spectrum to be available for operating these devices as efficiently and inexpensively as possible.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Systems, methods and apparatus that provide Bloom filters to limit use of transport resources in Internet of Things (IoT) scenarios are disclosed. The systems, methods, and apparatus allow efficient and less expensive data collection from remote wireless apparatus and networks through configuration of the parameters of a Bloom filter located at the wireless device or network. The embodiments have application in systems in which wireless transport resources may be expensive or scare, or in which the cost and/or availability of wireless transport resources may vary over time. For example, the embodiments have application to long term evolution (LTE) systems.

In the embodiments, the Bloom filter may be used to reduce the amount of data collected at the remote wireless apparatus to an amount of data better suited for transmission on one or more available wireless channels. The Bloom filter parameters may be configured based on air interface considerations such as bandwidth and cost. The configuration of the parameters of the Bloom filter may be performed dynamically based on parameters of the air interface on which the apparatus or network sends the collected data to a service or database for further processing. As the parameters on the air interface change, the parameters of the Bloom filter may be adapted to minimize use of expensive transport resources or increase use of less expensive transport resources. For example, as bandwidth becomes available, or becomes less costly, the parameters of the Bloom filter may be adapted to take advantage of the currently available resources of the air interface by allowing an increase or decrease in reporting time. In another example, the size and/or update frequency of the Bloom filter may be changed to adapt the number of false positives in the data sent by the remote device or network while using a selected amount of transport resources. The amount of available memory at the remote apparatus may be also be taken into account when dynamically configuring the Bloom filter.

Implementations of the embodiments include an apparatus implemented as remote device that receives collected data from at least one sensor circuit, generates reduced data from the collected data using a Bloom filter, receives an indication that the reduced data is to be transmit to a network, and, in response to receiving the indication, controls the transmitter to send the reduced data on a wireless channel to the network. The apparatus may further receive configuration data from the network on a wireless channel and configure the Bloom filter based on the received configuration data. In one example, the configuration data may be data associated with the size of the Bloom filter and/or other data that may be used to modify the number of false positive elements in the reduced data based on the configuration data. Also, the apparatus may receive control data from the network on a wireless channel. In another example, the indication that the reduced data is to be transmitted to the network may be generated in the apparatus based on the control data. Also, the control data may comprise channel data identifying the at least one channel on which to transmit the reduced data to the network.

Another implementation includes an apparatus that receives reduced data, where the reduced data was generated from data collected at the remote device using a Bloom filter and sent from a remote apparatus to a base station on at least one wireless channel, determines a parameter associated with the Bloom filter, determines configuration data for the Bloom filter based on the parameter, and, initiates sending of the configuration data from the base station to the remote device. For example, the parameter associated with the Bloom filter may include a number of false positives in the reduced data, a memory capacity available in the remote device and/or a size of the reduced data. The apparatus may further determine a parameter associated the at least one wireless channel, determine control data for the Bloom filter based on the at least one parameter associated the at least one wireless channel, and, initiate sending of the control data to the remote device For example, the control data may comprise information for timing the sending of the reduced data from the remote device to the base station on the at least one wireless channel. The control data may be determined based on the configuration parameters of the Bloom filter. The apparatus may comprise a portion of a system that also processes the received reduced data for purposes such as tracking entities such as people or vehicles, toll charging, etc.

### BRIEF DESCRIPTION OF THE DRAWINGS

FIG. 1 is a simplified diagram of a system in which implementations of Bloom filters to limit use of transport resources in IoT scenarios may be configured;

FIG. 2A is a flow diagram illustrating operations in an apparatus in which an example embodiment of the disclosure is implemented;

FIG. 2B is a flow diagram illustrating operations performed in an apparatus communicating with the apparatus in the flow diagram of FIG. 2A;

FIG. 3 is a diagram illustrating data flow in the system of FIG. 1;

FIG. 4 is a simplified block diagram of an example apparatus which may be implemented in the tracking system terminal of FIG. 1; and,

FIG. 5 is a simplified block diagram of an example apparatus which may be implemented in the tracking system server/database of FIG. 1.

### DETAILED DESCRIPTION

The system, method and apparatus will now be described by use of example embodiments. The example embodiments are presented in this disclosure for illustrative purposes, and not intended to be restrictive or limiting on the scope of the disclosure or the claims presented herein.

The disclosed embodiments provide advantages for use in devices/apparatus that perform data collection and transmission of the data to a network on wireless channels. In the embodiments, the use of Bloom filters at data collecting and transmitting devices allows a large set of collected data to be reduced to a reduced data set. The reduced data set maybe of a size that requires less transport resources to transmit to a destination, such a server in the cloud. The Bloom filter may also be dynamically configured to adapt to changing conditions, such as the increases or decreases in amount of collected data that is being collected at the apparatus, or changes in the spectrum resources available for the wireless channels on which the apparatus transmits the reduced data set. The Bloom filter is a data structure designed to tell you, rapidly and memory-efficiently, whether an element is present in a set. The Bloom filter is a probabilistic data structure in that it indicates that the element either definitely is not in the set or may be in in the set. False positive matches are possible, but false negatives are not. The larger a Bloom filter is, the smaller the number of false positives.

The embodiments provide advantages, for example, in systems where a selected group of entities are to be tracked by identifying the selected entities as the entities in the selected group pass by, or through, a sensor/scanner device, but where the scanner device also collects the identities of every entity that passes the sensor/scanner, whether or not the entity is in the selected group. For example, the sensor/scanner may be a license plate reader that reads and collects an ID tag (plate number) for every vehicle passing the sensor/scanner. However, a particular system may only be interested in tracking selected license plates that belong to vehicles in a specific group, such a as fleet of taxis, business vehicles, or Uber vehicles from among all the scanned license plates. By using the known identities of the license plates of the taxis, business vehicles, or Uber vehicles, a Bloom filter can be configured to generate a reduced data set from the actual larger set of data in the scanned and collected data set. The Bloom filter may be used to decide whether a collected license plate ID tag is present in the set of ID tags of the selected group to generate the reduced data set, with the condition that false positives may be included in the reduced data set. The size of the Bloom filter may be configured to be of a size to generate a reduced data set that includes a selected number of false positives. The size of the Bloom filter may be adapted as desired by the operator of the tracking system.

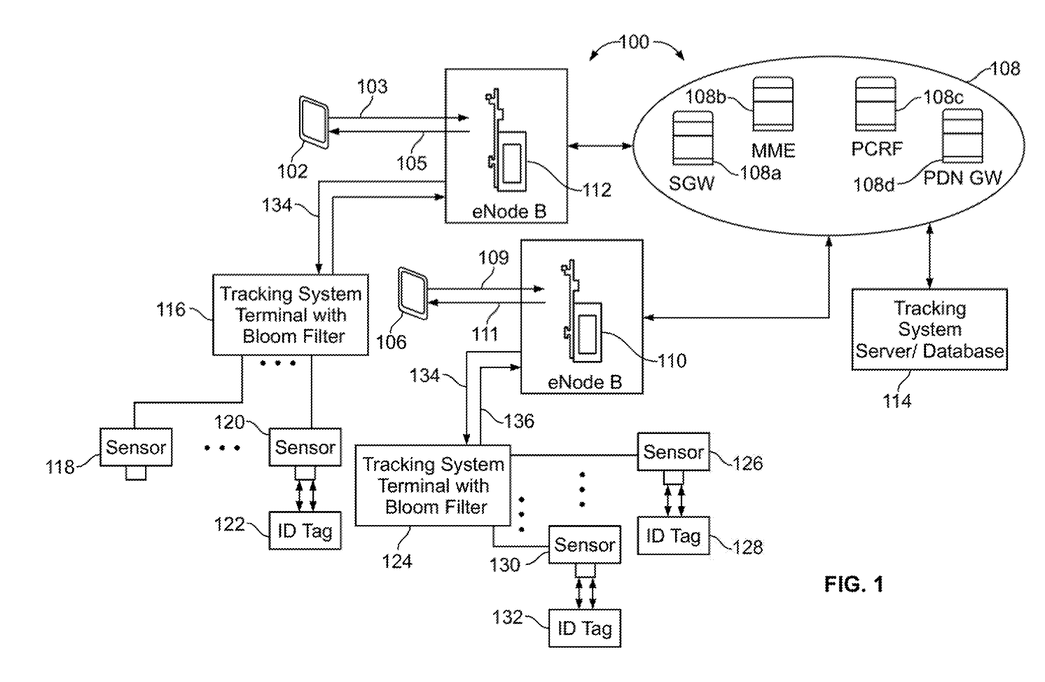

FIG. 1 is a simplified diagram of a system in which an example implementation of Bloom filters to limit use of transport resources in IoT scenarios may be configured. FIG. 1 shows a system 100 including core network infrastructure 108, eNode B 110, and eNode B 112. Core network infrastructure includes serving gateway (SGW) 108a, mobility management entity (MME) 108b, policy and charging rules function (PCRF) 108c, and packet data network gateway (PDN GW) 108d. SGW 108a, MME 108b, PCRF 108c, and PDN GW 108d provide the functions for overall control and management of wireless traffic in network 100. The eNode B 110 and eNode B 112 provide radio channel interfaces for voice and data communications between the core network 108 and devices such as devices 102 and 106. Example devices 102 and 106 are shown operating in the RF coverage area of eNode B 110 and eNode B 112, respectively. Device 102 is shown transmitting signals on an uplink channel 103 from to eNode B 112 and receiving signals on downlink channel 105 from eNode B 112. Similarly, device 106 is shown transmitting signals on an uplink channel 109 to eNode B 110 and receiving signals on downlink channel 111 from eNode B 110. There may be any number of devices such as devices 102 and 106 operating in system 100. FIG. 1 also shows apparatus 116 which is configured as a “Tracking System Terminal with Bloom filter”. Apparatus 116 is shown as connected to sensor 118 and sensor 120. Additionally, FIG. 1 also shows apparatus 124 which is also configured as a “Tracking System Terminal with Bloom filter”. Apparatus 124 is shown as connected to sensor 126 and sensor 130. Tracking system server/database 114 is shown as connected to core network 108. Tracking system server/database 114 may be geographically located anyway near or remote to apparatus 116 and 124 and may be connected to core network 108 through the internet. Tracking system server/database 114 may be representative of server functions or server systems provided by one or more servers or computing devices that may be co-located or geographically dispersed.

In the implementation of FIG. 1, sensors 118, 120, 126, and 130 may be configured as optical/RFID sensors for reading ID Tags. In FIG. 1, sensor 120 is shown reading ID Tag 122 and sensor 130 is shown reading ID Tag 132. In various examples of the implementation, sensors 118, 120, 126, and 130 may be license plate readers at a toll booth, airport entryway, or parking garage entry identifying passing automobiles, or, work badge readers identifying passing or entering employees. In other examples, 116 and 124 may also be implemented as any other type of apparatus, fixed or mobile, that collects data by identifying vehicles, persons, or objects using any source, sensors or otherwise. The Bloom filters in apparatus 116 and 124 are configured based on knowledge of a known group of vehicles, persons, or objects being tracked (entities of interest) to filter for that known group from all data collected. The known group may be for example, a group of paid subscribers, vehicles belonging to a group that gets a special discount, a group of select people, etc. For example, the Bloom filter in apparatus 116 is used to generate a reduced data set from a collected data set. The collected data set may include the sensed ID tags of all vehicles that pass by sensors 126, or 130. The reduced data set is the set generated by applying the Bloom filter to the collected data, which may be much smaller depending on the size of the Bloom filter. The application of the Bloom filter basically generates the reduced data as guaranteed to include all ID tags in the collected data that belong to entities of interest. Depending on the size and configuration of the Bloom filter the reduced data also includes a number of false positives.

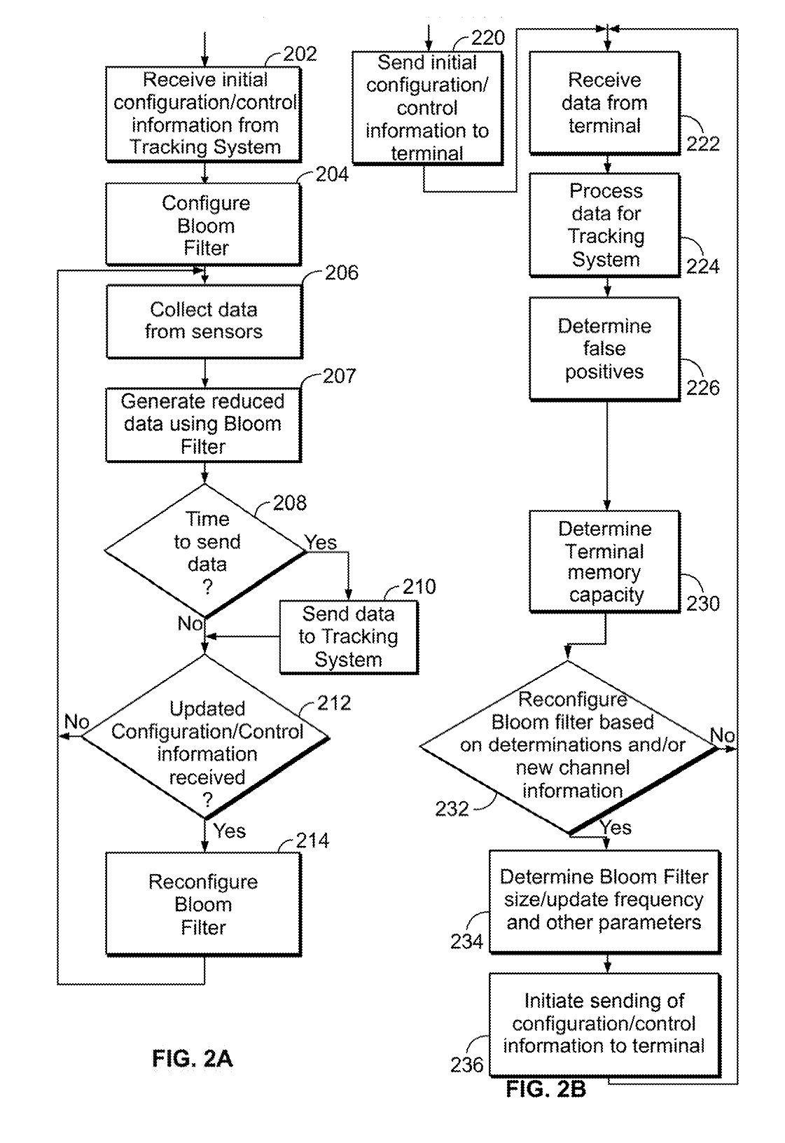

FIG. 2A is a flow diagram illustrating operations in an apparatus configured according to an example implementation. In one example, the operations of FIG. 2A may be performed by an apparatus implemented as tracking system terminal 116 or 124 of FIG. 1. FIG. 2A maybe explained with reference to FIG. 1 and tracking system terminal (apparatus) 124.

The process begins at 202 where tracking system terminal 124 receives initial configuration/control information from eNode B 110 on downlink 134. The configuration/control information may include configuration information for configuring the Bloom filter in tracking system terminal 124. The configuration information may include data for configuring the Bloom filter to be of a certain size. Generally, the larger the size of the Bloom filter, the more accurately the Bloom filter can construct a reduced data from the collected data set, i.e., the fewer the number of false positives will be in the reduced data set. The configuration information may include a complete Bloom filter structure to be implemented on tracking system terminal 124 or may include information for updating the current Bloom filter structure on tracking system terminal 124. The configuration/control information may also include information indicting when tracking system terminal 124 should be sending data to eNode N 110 and information about which channels of system 100 tracking system terminal 124 should be using to send the data on uplink 134. In an example implementation, the Bloom filters may be configured based on knowledge of the identities of a fleet of selected taxis that tracking system 114 wants to track from among all vehicles that are identified by tracking system terminal 116 and 124 as passing by sensors 118, 120, 126 and 130.

At 204, tracking system terminal 124 configures the Bloom filter based on the configuration information. Next, at 206, tracking system terminal 124 receives collected data that is collected by sensors 126 and 130. Sensors 126 and 130 may read and identify every vehicle that passes through the sensors by, for example, reading the vehicle's license plate number, or by identifying another type of identification or RF ID code associated with the vehicle. At 207, the collected data collected at operation 206 is then used to generate reduced data using the Bloom filter. The data collected at 206 may be collected over a desired time period according to the control data received at operations 202. At 208, a determination is made as to whether or not it is time to send the reduced data to the location tracking system 114. The tracking system terminal may perform the determination at 208 based on receiving an indication that it is time to send the reduced data to the location tracking system 114. The indication may be internally generated in tracking system terminal 124 based on the control data received at operation 202.

If it is determined, at 208, that it is time to send the data to the location tracking system 114, the process moves to 210. At 210, tracking system terminal 124 sends the reduced data over uplink 136 to eNode B 110. Tracking system terminal 124 may send the reduced data on channels that have been designated in the control information received at operation 202. Alternately, tracking system terminal 124 may send the reduced data on channels as negotiated with eNode B 110.

Next, at 212, tracking system terminal 124 determines whether updated configuration/control information has been received from eNode B 110 over downlink 134. If updated configuration/control information has been received from eNode B 110, the process moves to 214. At 214, the Bloom filter is reconfigured according to the updated configuration/control information. The process then returns to 206 where tracking system terminal 124 continues to collect data from sensors 126 and 130. If updated configuration/control information has not been received from eNode B 110, the process moves from 212 back to 206 where tracking system terminal 124 continues to collect data from sensors 126 and 130. The process then continues repeating operations 206, 207, 210, 212, and/or 214, as tracking system terminal 124 operates. The implementation of FIG. 2 may also be implemented in tracking system terminal 116. Other example, implementations of FIG. 2 maybe used to collect any type of data and provide reduced data for any type of systems in which the collected data includes a number of elements reducible by using a Bloom filter.

FIG. 2B is a flow diagram illustrating operations performed in an apparatus communicating with the apparatus in the flow diagram of FIG. 2A. In one example, the operations of FIG. 2A may be performed by an apparatus implemented as tracking system server/database 114 of FIG. 1. FIG. 2B maybe explained with reference to FIG. 1 and tracking system server/database (apparatus) 114.

The process begins at 220. At 220 tracking system server/database 114 sends initial configuration/control information to tracking system terminal 124. This is the configuration/control information that is received by apparatus 124 at 202 of FIG. 2A. The configuration information may include data to cause tracking system terminal 124 to configure the Bloom filter to be of a certain size. Tracking system server/database 114 may cause tracking system terminal s 124 to increase the size of the Bloom filter to more accurately construct reduced data from the collected data set having a fewer the number of false positives. The configuration information may include a complete Bloom filter structure to be implemented on tracking system terminal 124 or may include information for updating the current Bloom filter structure on apparatus 124. The configuration/control information may also include control information causing tracking system terminal 124 to send data to tracking system server/database 114 through eNode N 110 at certain times or in certain time periods. The control information may also include information to cause tracking system terminal 124 to send the reduced data on particular channels on uplink 134. In an example implementation, the Bloom filters may be configured based on knowledge of the identities of a fleet of selected taxis that tracking system server/database 114 wants to track from among all vehicles that are identified by tracking system terminal 124 as passing by sensors 126 and 130. Tracking system server/database 114 may include a database that includes the identities of each of selected taxis of the fleet of taxis that the tracking system wants to track and maintain/update the database as taxis are added or removed from the fleet. In one example, tracking system server/database 114 may be configured to create charging information for the taxis of the selected fleet of taxis as the taxis pass through the sensors.

At 222, as tracking system terminal 124 sends the reduced data at 210 of FIG. 2A, tracking system server/database 114 receives the reduced data. At 224 tracking system server/database 114 processes the reduced data for the tracking system. In one example, tracking system server/database 114 may be configured to create tracking and/or charging information for the selected taxis of the fleet of taxis as the taxis pass through the sensors. Based on its database of selected taxis that currently belong to the fleet, system server/database 114 may remove false positives from the reduced data set and create a list having information associated with the movement of the selected taxis through the sensor coverage areas to use, for example, for tracking and/or charging tolls.

Next, at 226, tracking system server/database 114 determines a number of false positives. In one example, the number of false positives may be determined from the number of false positives removed from the reduced data at 224. In another example, the number of false positives may be determined from the average number of false positives removed from the reduced data in multiple iterations of operation 224 for a set number of iterations, or over a time period as operation 224 is performed.

At 230, tracking system server/database 114 determines the memory capacity of tracking system terminal 124 associated with use of the Bloom filter. The memory capacity may be determined based on the size of the memory in tracking system terminal 124 and the size of memory needed by the Bloom filter. The amount of collected data and/or the amount of the reduced data associated with the current control information/reporting times that is stored by tracking system terminal 124 as it operates may also be taken into consideration. Tracking system server/database 114 may have prior knowledge of these parameters related to memory capacity of tracking system terminal 124 or may receive information on the parameters as it is sent by tracking system terminal 124.

At 232, tracking system server/database 114 determines whether the Bloom filter of tracking system terminal 124 should be reconfigured based on the determinations performed at 226 and 230, and/or new information associated with the channels available for uplink 136. If it is determined that the Bloom filter is to be reconfigured the process moves to 234. If it is determined that the Bloom filter is not to be reconfigured the process moves back to 222 and repeats operations 222, 224, 226, and 232. The determination at 232 may be performed based on any combination of these factors by determining if reconfiguration of the Bloom filter is needed to achieve a desired efficiency or desired cost associated with the sending of the reduced data from tracking system terminal 124 over uplink 136 to tracking system server/database 114.

At 234, tracking system server/database 114 determines an updated Bloom filter size, a new update frequency and/or other updated parameters. For example, in time periods where vehicle traffic passing through sensors 126 and 130 is going to be minimal compared to other time periods, the traffic load on channels of uplink 136 is light, and bandwidth on uplink 136 costs less, tracking system server/database 114 may determine that the size of the Bloom filter may be kept the same and the reporting time/periods may be set more frequently. In another example, in time periods where vehicle traffic passing through sensors 126 and 130 is going to be heavy compared to other time periods, the traffic load on channels of uplink 136 is heavy, and bandwidth on uplink 136 costs more, tracking system server/database 114 may determine that the size of the Bloom filter may be increased to reduce the number of false positives, and the reporting time/periods may be set less frequently. In another example, if it is determined that memory capacity of the tracking system terminal 124 is approaching capacity during peak vehicle traffic times, the size of the Bloom filter may be reduced during those peak vehicle traffic times to provide more memory capacity for collected and reduced data in tracking system terminal 124.

Next, at 236, tracking system server/database 114 initiates sending of the configuration and control data to tracking system terminal through eNodeB 110 of system 100. The process then returns to 222 and is repeated.

In other implementations, one or more of the operations of FIG. 2B may be performed by tracking system terminal 124. The location at which the various functions of FIGS. 2A and 2B are performed depends on the types of devices/apparatus used in tracking system terminal 124 and/or tracking system server/database 114, and on which resources a system operator desires to conserve.

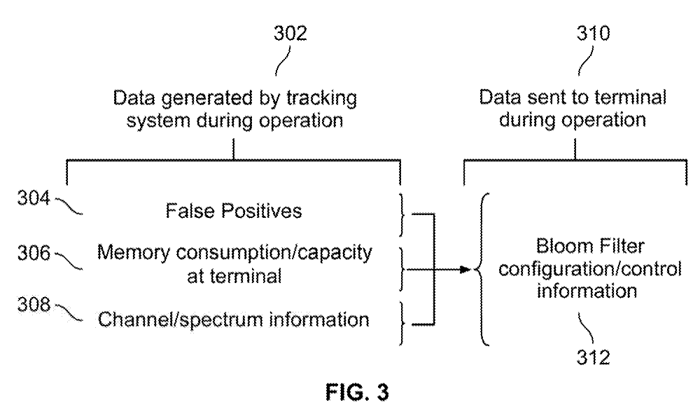

FIG. 3 is a simplified diagram illustrating data generation and utilization in the system of FIG. 1 as the operations of FIGS. 2A and 2B are performed. Data generated by tracking system during operation 302 includes the number of false positives 304 in the reduced data sent by tracking system terminal 124, memory consumption/capacity 306 at tracking system terminal 124, and channel/spectrum information 308 for uplink 136. This data generated by tracking system during operation 302 is processed through the process of FIGS. 2A and 2B to generate data sent to terminal during operation 310 that includes Bloom filter configuration/control information 312. The Bloom filter configuration/control information 312 is utilized by tracking system terminal 124 to configure the Bloom filter appropriately.

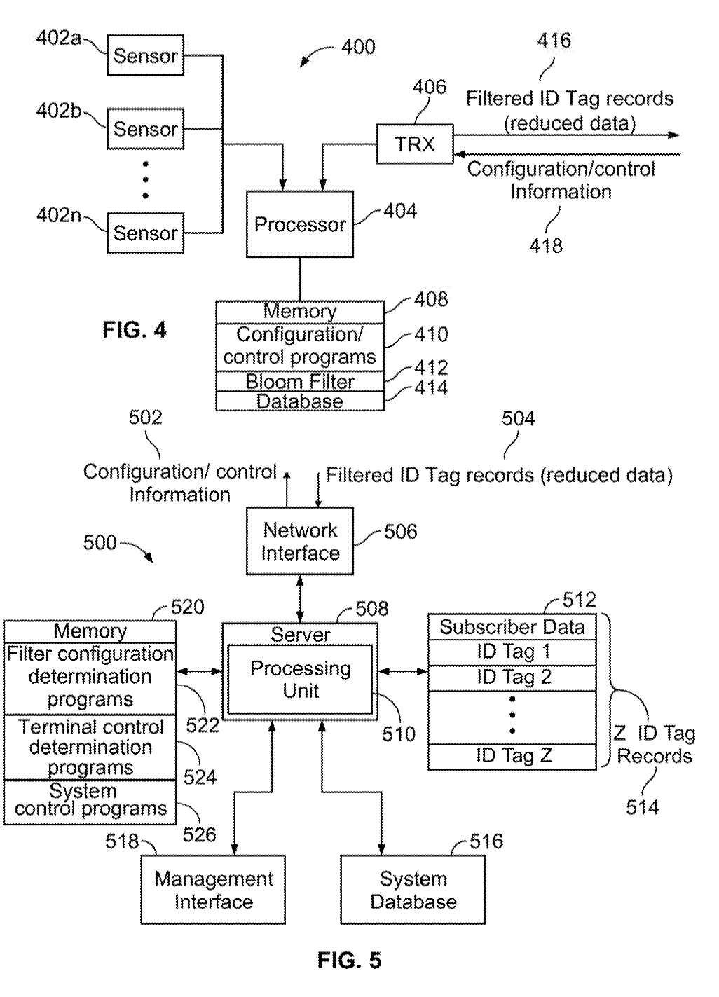

FIG. 4 is a simplified block diagram of an example apparatus which may be implemented in the tracking system terminal of FIG. 1 to perform the operations shown in FIG. 2A. Apparatus 400 represents a possible implementation of tracking system terminal 124, tracking system terminal 116, or any other device or apparatus that may operate in network 100, according to the embodiments of the disclosure. Device 400 includes processor 404 and memory 408 which is shown as including program code or instructions for configuration/control programs 410, Bloom filter 412, and database 414 that perform functions according to the embodiments. Memory 408 may be implemented as any type of computer readable storage media in apparatus 400, including non-volatile and volatile memory. Memory 408 may also include instructions in the form of code for running the operating system to control the operations of apparatus 400, for example for transmitting/receiving data using transceiver (TRX) 406 and collecting data from sensors 402a-402n. In FIG. 4 the data collected from sensors 402a-402n may include recorded ID tags that each indicates the identity of a detected vehicle or other entity. Processor 404 may comprise one or more processors, or other control circuitry or any combination of processors and control circuitry. Processor 404 provides overall control of device 400 and the other functional blocks shown in FIG. 4A by implementing instructions and code in memory 408 to provide functions for operation in network 100.

In implementations of the embodiments, apparatus 400 and its transceiver TRX 406 may be operable to transmit Filtered ID Tag records (reduced data) 416 and receive configuration/control information 418 on channels in one or more spectrum allocations that are allowed in designated frequency bands according to the 3GPP LTE standards specification or any other standard specification supported by network 100. In other example implementations, transceiver TRX 406 may be operable to transmit and receive on other wireless channels such as 802.11 Wi-Fi channels, channels in the television white space (TVWS) frequencies, or other applicable channels.

In an implementation of apparatus 400, configuration/control programs 410 cause processor 404 to control apparatus to perform operations as shown in FIG. 2A. Configuration/control programs 410 operate according to configuration control information 418 received at TRX 406. Bloom filter 412 is used to generate filtered ID tag records (reduced data) 416 from data collected at sensors 402a-402n. Database 414 may be used to store collected and/or reduced data as apparatus 400 operates.

FIG. 5 is a simplified block diagram of an example apparatus which may be implemented in the tracking system server/database of FIG. 1. Apparatus 500 includes server 508 including processing unit 510, and memory 520 which is shown as including program code or instructions for Bloom filter configuration determination programs 522, terminal control determination programs 524, and system control programs 526. Apparatus 500 also includes management interface 518, system database 516 and subscriber data database 512.

Memory 520, subscriber database 512, and system database 516 may be implemented in any type of computer readable storage media in apparatus 520, including non-volatile and volatile memory. Memory 520 may also include instructions in the form of code for running the operating system to control the operations of apparatus 500, for example for transmitting/receiving data on network interface 506. Processing unit 510 may comprise one or more processors, or other control circuitry or any combination of processors and control circuitry. Processing unit 510 provides overall control of device 500 and the other functional blocks shown in FIG. 5 by implementing instructions and code in memory 520 to provide functions for operation in system 100. Management interface 518 may function to allow a tracking system manager to manually input control information/programs into apparatus 500 or receive data/information on the functions of apparatus 500 as it operates. Subscriber data database 512 may be used to store subscriber data. In an example implementation, subscriber data 512 may comprises ID tag records of all vehicles belonging to a fleet of which the tracking system desires to track individual vehicles as the vehicles are detected by a tracking system terminal. Subscriber data 512 may be used to process cost/tracking data for vehicles in the fleet. Subscriber data 512 may also be used to determine false positives and the number of false positives in the reduced data set received from a tracking terminal. Since the Bloom filter may be configured to generate an allowable number of false positives from vehicles flagged as being of interest (belonging to the fleet of interest) when the vehicles are not in the fleet, apparatus 500 may compare the reduced data received to the subscriber database to determine which ID tags in the reduced data are false positives.

In implementations of the embodiments, apparatus 500 and its network interface 506 may be operable to received Filtered ID Tag records (reduced data) 504 and transmit configuration/control information 502 from and to tracking terminals, such as tracking terminal 124 of system 100. Filter configuration determination programs 522 cause processing unit 510 to control apparatus 500 to perform operations as shown in FIG. 2B. Filter configuration determination programs 522 operate to generate filter configuration control information to be sent to tracking terminals in configuration/control information 502 to configure Bloom filters in the tracking terminals. Terminal control determination programs 524 also cause processing unit 510 to control apparatus 500 to perform operations as shown in FIG. 2B. Terminal control determination programs 524 operate to generate filter control information to be sent to tracking terminals in configuration/control information 502.

Server 508 is illustrated as a single server but may be representative of server functions or server systems provided by one or more servers or computing devices that may be co-located or geographically dispersed. The term server as used in this disclosure is used generally to include any computing devices or communications.

The example embodiments disclosed herein may be described in the general context of processor-executable code or instructions stored on memory that may comprise one or more computer readable storage media (e.g., tangible non-transitory computer-readable storage media such as memory 408 or 508). As should be readily understood, the terms “computer-readable storage media” or “non-transitory computer-readable media” include the media for storing of data, code and program instructions, such as memory 408 or 508, and do not include portions of the media for storing transitory propagated or modulated data communication signals

While embodiments have been disclosed as having functions implemented on access points, apparatus, servers and/or devices operating in a network, one or more of the functions may be implemented on different types of equipment. For example, one or more of the functions in the system shown as implemented on a server located in network infrastructure, or on a terminal operating in the coverage area of a network, may be implemented on a device, such as mobile device, laptop computer or any other suitable device operating in a network.

While the functionality disclosed herein has been described by illustrative example using descriptions of the various components and devices of embodiments by referring to functional blocks and processors or processing units, controllers, and memory including instructions and code, the functions and processes of the embodiments may be implemented and performed using any type of processor, circuitry or combinations of processors and/or circuitry and code. This may include, at least in part, one or more hardware logic components. For example, and without limitation, illustrative types of hardware logic components that can be used include field programmable gate arrays (FPGAs), application specific integrated circuits (ASICs), application specific standard products (ASSPs), system-on-a-chip systems (SOCs), complex programmable logic devices (CPLDs), etc. Use of the term processor or processing unit in this disclosure is mean to include all such implementations.

The disclosed implementations included an apparatus comprising a processor, a transmitter coupled to the processor, the transmitter configured to transmit on at least one wireless channel, and memory coupled to the processor, the memory including code executable to cause the processor to receive collected data from at least one sensor circuit, generate reduced data using a Bloom filter, receive an indication that the reduced data is to be transmit to a network, and, in response to receiving the indication, control the transmitter to send the reduced data on the at least one wireless channel to the network. The at least one channel may comprise a first at least one channel, the apparatus may include a receiver configured to receive on a second at least one wireless channel and the code may further executable to cause the processor to control the receiver to receive configuration data from the network on the second at least one channel, and, configure the Bloom filter based on the configuration data. The configuration data may comprise data associated with the size of the Bloom filter. The reduced data may include one or more false positive elements and the code may be further executable to cause the processor to configure the Bloom filter to modify the number of false positive elements in the reduced data based on the configuration data. The code may be further executable to cause the processor to control the receiver to receive control data from the network on the second at least one wireless channel, and the indication that the reduced data is to be transmitted to the network may be generated in the apparatus based on the control data. The control data may comprise timing data on when to transmit the reduced data to the network. The control data may comprise channel data identifying the at least one channel on which to transmit the reduced data to the network. The transmitter may be configured to transmit according to the long term evolution standard.

The disclosed implementations also include an apparatus comprising a processor, a receiver coupled to the processor, and memory coupled to the processor, the memory including code executable to cause the at least one processor to receive reduced data, the reduced data generated from collected data using a Bloom filter at a remote device and sent from the remote device to a base station on at least one wireless channel, determine at least one parameter associated with the Bloom filter, determine configuration data for the Bloom filter based on the at least one parameter, and, initiate sending of the configuration data from the base station to the remote device. The at least one parameter may comprise a number of false positives in the reduced data. The at least one parameter may comprise a memory capacity available in the remote device. The at least one parameter may comprise a size of the reduced data. The configuration data may comprise size data associated with the Bloom filter. The code may be further executable to cause the at least one processor to determine at least one parameter associated the at least one channel, determine control data for the Bloom filter based on the at least one parameter associated the at least one wireless channel, and, initiate sending of the control data to the remote device. The control data may comprise information for timing the sending of the reduced data from the remote device to the base station on the at least one wireless channel;

The disclosed implementations further included a system comprising a controller, one or more data collectors coupled to the controller, a Bloom filter structure having an input coupled to the controller, and a transceiver coupled to the output of the Bloom filter structure, the transceiver configured to transmit on at least one wireless channel, wherein the controller is configured to control the system to receive configuration data at the transceiver and configure the Bloom filter according to the configuration data, receive control data at the transceiver and configure the controller according to the control data, receive collected data from the one or more data collectors, generate reduced data from the collected data using the Bloom filter, control the transmitter to transmit the reduced data at selected times on a selected channel of the at least one wireless channel according to the control data. The control data may comprise an identification of the selected channel and a time period within which the selected times are included. The configuration data may comprise data associated with the size of the Bloom filter. The reduced data may include a number of false positive elements and the controller may increase the number of false positives elements by configuring the Bloom filter according to the configuration data. The reduced data may include a number of false positive elements and the controller may decrease the number of false positives elements by configuring the Bloom filter according to the configuration data.

Although the subject matter has been described in language specific to structural features and/or methodological acts, it is to be understood that the subject matter defined in the appended claims is not necessarily limited to the specific features or acts described above. Rather, the specific features and acts described above are disclosed as example embodiments, implementations, and forms of implementing the claims and these example configurations and arrangements may be changed significantly without departing from the scope of the present disclosure. Moreover, although the example embodiments have been illustrated with reference to particular elements and operations that facilitate the processes, these elements, and operations may or combined with or, be replaced by, any suitable devices, components, architecture or process that achieves the intended functionality of the embodiment. Numerous other changes, substitutions, variations, alterations, and modifications may be ascertained to one skilled in the art and it is intended that the present disclosure encompass all such changes, substitutions, variations, alterations, and modifications as falling within the scope of the appended claims.

What is claimed is:

1. An apparatus comprising:
a processor;
a transmitter coupled to the processor, the transmitter configured to transmit on at least one wireless channel; and,
memory coupled to the processor, the memory including code executable to cause the processor to:
receive collected data from at least one sensor circuit;
generate reduced data using a Bloom filter;
receive an indication that the reduced data is to be transmit to a network; and,
in response to receiving the indication,
control the transmitter to send the reduced data on the at least one wireless channel to the network.

2. The apparatus of claim 1, wherein the at least one channel comprises a first at least one channel, the apparatus includes a receiver configured to receive on a second at least one wireless channel and the code is further executable to cause the processor to:
control the receiver to receive configuration data from the network on the second at least one channel; and,
configure the Bloom filter based on the configuration data.

3. The apparatus of claim 2, wherein the configuration data comprises data associated with the size of the Bloom filter.

4. The apparatus of claim 3, wherein the reduced data includes one or more false positive elements and the code is further executable to cause the processor to configure the Bloom filter to modify the number of false positive elements in the reduced data based on the configuration data.

5. The apparatus of claim 1, wherein the code is further executable to cause the processor to control the receiver to receive control data from the network on the second at least one wireless channel, and the indication that the reduced data is to be transmit to the network is generated in the apparatus based on the control data.

6. The apparatus of claim 5, wherein the control data comprises timing data on when to transmit the reduced data to the network.

7. The apparatus of claim 5, wherein the control data comprises channel data identifying the at least one channel on which to transmit the reduced data to the network.

8. The apparatus of claim 1, wherein the transmitter is configured to transmit according to the long term evolution standard.

9. An apparatus comprising:
a processor;
a receiver coupled to the processor; and,
memory coupled to the processor, the memory including code executable to cause the at least one processor to:
receive reduced data, the reduced data generated from collected data using a Bloom filter at a remote device and sent from the remote device to a base station on at least one wireless channel;
determine at least one parameter associated with the Bloom filter;
determine configuration data for the Bloom filter based on the at least one parameter; and,
initiate sending of the configuration data from the base station to the remote device.

10. The apparatus of claim 9, wherein the at least one parameter comprises a number of false positives in the reduced data.

11. The apparatus of claim 9, wherein the at least one parameter comprises a memory capacity available in the remote device.

12. The apparatus of claim 9, wherein the at least one parameter comprises a size of the reduced data.

13. The apparatus of claim 9, wherein the configuration data comprises size data associated with the Bloom filter.

14. The apparatus of claim 9, wherein the code is further executable to cause the at least one processor to:
determine at least one parameter associated the at least one channel;
determine control data for the Bloom filter based on the at least one parameter associated the at least one wireless channel; and,
initiate sending of the control data to the remote device.

15. The apparatus of claim 14, wherein the control data comprises information for timing the sending of the reduced data from the remote device to the base station on the at least one wireless channel;

16. A system comprising:
a controller;
one or more data collectors coupled to the controller;
a Bloom filter structure having an input coupled to the controller; and,
a transceiver coupled to the output of the Bloom filter structure, the transceiver configured to transmit on at least one wireless channel, wherein the controller is configured to control the system to:
receive configuration data at the transceiver and configure the Bloom filter according to the configuration data;
receive control data at the transceiver and configure the controller according to the control data;
receive collected data from the one or more data collectors;
generate reduced data from the collected data using the Bloom filter;
control the transmitter to transmit the reduced data at selected times on a selected channel of the at least one wireless channel according to the control data.

17. The system of claim 16, wherein the control data comprises an identification of the selected channel and a time period within which the selected times are included.

18. The system of claim 16, wherein the configuration data comprises data associated with the size of the Bloom filter.

19. The system of claim 16, wherein the reduced data includes a number of false positive elements and the controller increases the number of false positives elements by configuring the Bloom filter according to the configuration data.

20. The system of claim 16, wherein the reduced data includes a number of false positive elements and the controller decreases the number of false positives elements by configuring the Bloom filter according to the configuration data.
